(19) United States
(12) Patent Application Publication
(10) Pub. No.: US 2026/0301558 A1
(43) Pub. Date: Oct. 1, 2026

(54) DIGITAL KEY CLOUD SERVICES PLATFORM FOR PROVISIONING VEHICLE PUBLIC KEY CERTIFICATES

(71) Applicants: DENSO International America, Inc., Southfield, MI (US); DENSO CORPORATION, Kariya-city (JP)

(72) Inventors: Christopher SWIERCZYNSKI, St. Clair Shores, MI (US); Collin James, Farmington Hills, MI (US); Jonathan Swierczynski, St. Clair Shores, MI (US)

(73) Assignees: DENSO International America, Inc., Southfield, MI (US); DENSO CORPORATION, Kariya-city (JP)

(21) Appl. No.: 19/550,481

(22) Filed: Feb. 26, 2026

Related U.S. Application Data
(60) Provisional application No. 63/778,012, filed on Mar. 26, 2025.
(60) Provisional application No. 63/778,021, filed on Mar. 26, 2025.
(60) Provisional application No. 63/778,031, filed on Mar. 26, 2025.

(51) Int. Cl. G08B 25/10; B60R 25/24

(52) U.S. Cl. CPC G08B 25/10; B60R 25/24

(57) ABSTRACT

A digital key cloud services platform for managing digital friend keys for a plurality of vehicles is provided. In some examples, the digital key cloud services platform includes a key tracking service configured to track digital friend keys issued to a plurality of friend devices and a key management service configured to provide a key expiry scheduler service for managing termination of expired digital friend keys identified for termination.

### CROSS-REFERENCE TO RELATED APPLICATIONS

This application claims the benefit of U.S. Provisional Application No. 63/778,012, filed on Mar. 26, 2025, U.S. Provisional Application No. 63/778,021, filed on Mar. 26, 2025, and U.S. Provisional Application No. 63/778,031, filed on Mar. 26, 2025. The entire disclosures of each of the above applications are incorporated herein by reference.

### FIELD

The present disclosure relates to provisioning devices with a public key certificate, and particularly to a digital key cloud services platform configured for provisioning a vehicle with a vehicle public key certificate.

### INTRODUCTION

The information provided in this section is for the purpose of generally presenting the context of the disclosure. The work of the presently named inventors, to the extent it is described in this section, as well as aspects of the description that may not otherwise qualify as prior art at the time of filing, are neither expressly nor impliedly admitted as prior art against the present disclosure.

Digital keys are increasingly being used to authenticate access to or operation of a vehicle. Digital keys may be stored in the memory of a mobile device (e.g., smartphone, smartwatch, or similar smart wearable devices) and provide convenient access to a vehicle. Typically, a vehicle owner may also assign a temporary digital key to another. This process becomes more complex when the assignee has a mobile device from a device manufacturer that is different from the vehicle owner.

### SUMMARY

This section provides a general summary of the disclosure, and is not a comprehensive disclosure of its full scope or all of its features.

One example of the present disclosure provides a digital key cloud services platform for managing digital friend keys for a plurality of vehicles. In some examples, the digital key cloud services platform includes a key tracking service configured to track digital friend keys issued to a plurality of friend devices, wherein the digital friend keys are each respectively tied to one of the plurality of friend devices to entitle a friend device of the plurality of friend devices tied thereto access to one of the plurality of vehicles and a key management service configured to provide a key expiry scheduler service for managing termination of expired digital friend keys, wherein the expired digital friend keys correspond with respective ones of the digital friend keys identified for termination.

In some examples, the key tracking service manages a digital key database configured to associate a digital key record with each of the digital friend keys.

In some examples, each of the digital key records includes an expiration date representing a date on which the digital friend key associated therewith is intended for termination.

In some examples, the key expiry scheduler service is configured to query the digital key database to identify the expired digital friend keys.

In some examples, the key expiry scheduler service is configured to identify the expired digital friend keys to include the digital friend keys associated with the digital key records that have the expiration date in excess of a selected expiration date.

In some examples, the key tracking service is configured to set the expiration date for each of the digital key records according to entitlements specified by a digital key integration service of a vehicle original equipment manufacturer (OEM) services platform of a vehicle OEM of the vehicle associated therewith.

In some examples, each of the digital key records includes a keyExpired flag, wherein the key tracking service sets the keyExpired flag to an unexpired state to indicate that the digital friend key associated therewith is unexpired and to an expired state to indicate that the digital friend key associated therewith has expired.

In some examples, the digital key records include a terminatedInVehicle flag, wherein the key tracking service sets the terminatedInVehicle flag to an active state to indicate that the digital key associated therewith has not been terminated in the vehicle tied thereto and to an inactive state to indicate that the digital friend key associated therewith has been terminated in the vehicle tied thereto.

In some examples, the key expiry scheduler service is configured to instruct the key tracking service to update the keyExpired flag from the unexpired state to the expired state for the digital key records associated with the expired digital friend keys.

In some examples, the key expiry scheduler service is configured to instruct the key management service to communicate a vehicle OEM termination request message to the vehicle OEM services platform of each of the vehicles associated with the expired digital friend keys.

In some examples, each vehicle OEM termination request message is operable to request the vehicle OEM services platform in receipt thereof to delete the digital friend key associated therewith from the vehicle tied thereto.

In some examples, the key management service is configured to receive vehicle OEM key terminated messages from the vehicle OEM services platforms to confirm deletion of the expired digital friend keys associated with the vehicle OEM termination request messages.

In some examples, the key expiry scheduler service is configured to instruct the key tracking service to update the terminatedInVehicle flag from the active state to the inactive state for the digital key records associated with the expired digital friend keys.

In some examples, the key expiry scheduler service is configured to instruct the key management service to communicate device OEM termination request messages to a device OEM services platform of each of the friend devices associated with the expired digital friend keys.

In some examples, the key expiry scheduler service is configured to instruct the key management service to communicate a device OEM termination notification message to a device OEM services platform of each of the friend devices associated with the expired digital friend keys.

In some examples, the digital friend keys operate independently of digital owner keys, wherein the digital owner keys are each respectively tied to one or more owner devices to entitle the owner device tied thereto access to one of the plurality of vehicles.

In some examples, the digital friend keys are friend keys defined according to the Car Connectivity Consortium® (CCC) Version 1.1.0 specification.

One example of the present disclosure provides a method for managing digital friend keys for a plurality of vehicles. In some examples, the method includes tracking digital friend keys issued to a plurality of friend devices with a key tracking service, wherein the digital friend keys are each respectively tied to one of the plurality of friend devices to entitle a friend device of the plurality of friend devices tied thereto access to one of the plurality of vehicles, managing a digital key database to associate a digital key record with each of the digital friend keys, wherein each of the digital key records includes an expiration date representing a date on which the digital friend key associated therewith is intended for termination, and managing termination of expired digital friend keys with a key expiry scheduler service of a key management service, wherein the expired digital friend keys correspond with respective ones of the digital friend keys that have the expiration date in excess of a selected expiration date.

In some examples, the method includes communicating a vehicle original equipment manufacturer (OEM) termination request message from the key management service to a vehicle OEM services platform of each of the vehicles having one of the expired digital friend keys.

In some examples, the method includes the digital friend keys being friend keys defined according to the Car Connectivity Consortium® (CCC) Version 1.1.0 specification.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a functional diagram illustrating a single tenant arrangement and a multi-tenant arrangement in accordance with an example of the present disclosure;

FIG. 2 is a functional diagram illustrating a digital key cloud services platform providing digital key sharing in accordance with an example of the present disclosure; and

FIG. 3 is a functional diagram illustrating a method for provisioning a vehicle with a vehicle public key certificate in accordance with an example of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In some examples, the present disclosure provides a digital key service for vehicles. The digital key service may implement and expand on the requirements of the Car Connectivity Consortium® (CCC) Version 1.1.0 specification (the CCC specification), the disclosure of which is hereby incorporated by reference in its entirety herein, and future versions of the specification.

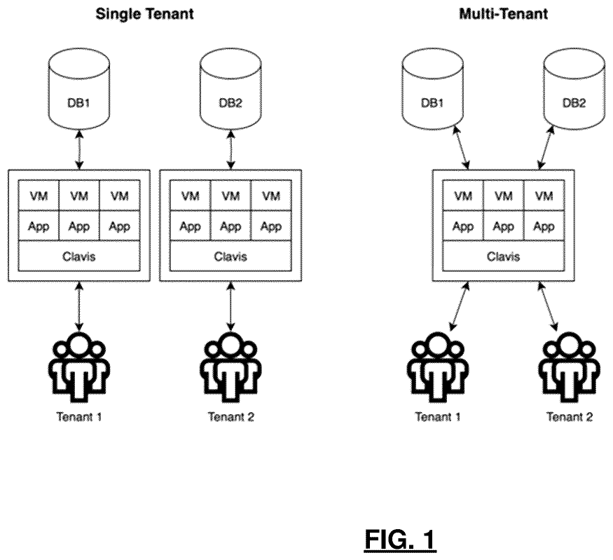

The present disclosure may be implemented in a single tenant or multi-tenant hosting environment. In either case, the digital key service optionally operates as a single instance, as shown in FIG. 1. The tenants of the digital key service may be vehicle OEMs. The digital key service may include an application programming interface (API) allowing tenants to communicate with the digital key service.

The digital key service may allow each tenant to configure the following information:
identifying information such as tenant name and CCC ID,
CCC-related certificates,
whether certificate signing is handled by the tenant or is delegated to the digital key service,
connections to and configurations for mobile device OEMs (e.g., Apple, Google, etc.), and
connection to and configuration for a vehicle integration service (VIS).

The digital key service may include support for suspending and resuming digital keys. For example, the digital key service may allow a user (e.g., a vehicle owner or vehicle user) or tenant to suspend a digital key and to resume a digital key that has been suspended. Upon receiving an instruction from the user or tenant to suspend a digital key or to resume a digital key that has been suspended, the digital key service may send a notification to the user or tenant that the vehicle feature has been suspended or the suspended vehicle feature has been resumed. In the example above, the digital key service may send a notification to the tenant that a digital key has been suspended or a suspended digital key has been resumed.

The tenant may choose whether to support the suspend/resume feature via a customization field that can be set during vehicle creation. Alternatively, the tenant may update the choice of whether to support the suspend/resume feature via a vehicle information update application programming interface (API).

In executing instructions to resume or suspend a digital key, the digital key service may consider the network connection status of a vehicle (i.e., offline/online). The digital key service may include an offline vehicle notification function in its API to allow tenants to notify the digital key service that a vehicle message could not be delivered, indicating the vehicle may be offline. The offline vehicle notification function may include an option for the tenant to resume attestations once the offline vehicle resumes communication with the digital key service.

With reference to the figures, FIG. 1 illustrates the digital key service (i.e., Clavis) operating in an example single tenant arrangement and in an example multi-tenant arrangement.

In the single tenant arrangement, Tenant 1 and Tenant 2 are single tenants. Each tenant interfaces with an instance of the digital key service that is different from the instance of any other tenant. Each application (i.e., App), virtual machine (i.e., VM), and database (i.e., DB1, DB2) is limited to providing services to a single tenant.

In the multi-tenant arrangement, Tenant 1 and Tenant 2 are tenants that share a single instance of the digital key service. Each application (i.e., App) and virtual machine (i.e., VM) provide services to the single instance of the digital key service and the shared tenants, collectively. However, as in the single tenant arrangement, each database (i.e., DB1, DB2) is limited to providing services to a single tenant. While the multi-tenant arrangement allows for tenants to share a single instance of the digital key service, the digital key service compartmentalizes or silos each tenant and generally prevents communication between tenants. Access to tenant data may be verified on each request by various access control methods, such as JWT verification, certificate-chain verification, and ensuring the caller is part of the requested tenant.

The digital key service may further implement subdomains to handle vehicle OEM requests. Each tenant may have a specific and separate subdomain that device OEMs can send requests to when performing requests for a specific vehicle OEM.

Thus, though in a multi-tenant arrangement, the tenant may have the same experience and the same information security as in a single tenant arrangement.

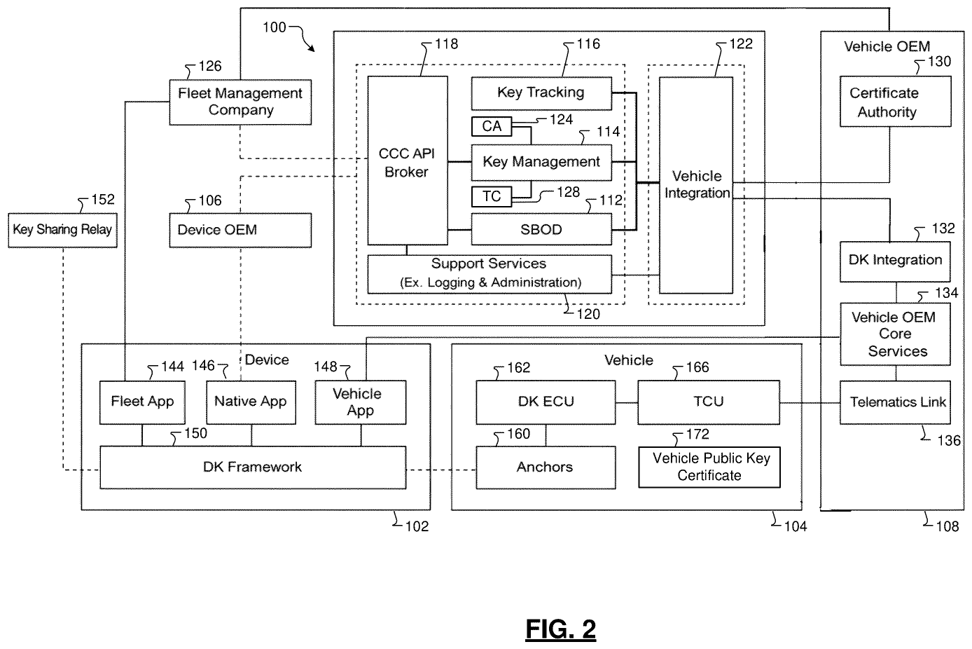

Referring to FIG. 2, a digital key cloud services platform 100 for providing digital key services is presented in accordance with an example of the present disclosure. In the illustrated instance, the digital key cloud services platform 100 is configured to facilitate digital key sharing between a device 102 and a vehicle 104, optionally based in part on messaging and other communications between a device OEM services platform 106 of a device OEM of the device 102 and a vehicle OEM services platform 108 of a vehicle OEM of the vehicle 104.

FIG. 2 illustrates a singular instantiation of each of the device 102 and the vehicle 104 for non-limiting purposes. In particular, the present disclosure contemplates the digital cloud services platform 100 concurrently supporting multiple instantiations of the device 102 and/or the vehicle 104, i.e., supporting interactions with multiple devices and/or multiple vehicles simultaneously.

In some circumstances, the device 102 corresponds with a friend device, i.e., device entitled access to the vehicle 104 as a friend via entitlements provided from an owner, and in other circumstances, the device 102 corresponds with an owner device, i.e., a device entitled access to the vehicle 104 as an owner via entitlements provided from the vehicle OEM.

In the event multiple friend and/or owner devices and/or multiple vehicles are simultaneously supported for different OEMs, additional instantiations of the device OEMs services platform 106 and/or the vehicle OEM services platform 108 are provided for each OEM.

In some examples, the digital key cloud services platform 100 includes a server-based owner device (SBOD) service 112, a key management service 114, a key tracking service 116, a CCC application programming interface (API) broker service 118, an administrative support service 120, a vehicle integration service 122, a cloud certificate authority (CA) service 124, and a tenant context (TC) service 128.

In this regard, the digital key cloud services platform 100 comprises a variety of hardware and software components operable to support a number of processes, protocols, communications, etc. accordingly, the digital key cloud services platform 100 is a comprehensive infrastructure that enables applications, devices, and systems to communicate, share data, and consume functionality across distributed environments. The OEM services platform 108 is similarly configured.

To this end, the digital key cloud services platform 100 and the OEM services platform 108 support various interfaces and protocols to facilitate the operations described herein and particularly include functionality operable to comply with the requirements of the CCC specification. The platforms, for example, include various APIs, services, services architectures, delivery mechanisms, etc., which are referenced without limitation to represent attendant functions, activities, and actions performed by the digital key cloud services platform 100 and the OEM services platform 108 in furtherance of the digital key services described herein.

The SBOD service 112 may implement the creation of digital keys. The SBOD service 112 may include the following sub-components:
Config—handles configuration of the web service,
Controller—defines the web APIs and accepts incoming requests to the APIs,
DAO—data persistence classes,
DTO—data transfer classes,
Gateway—handles outgoing requests to the Internet or other web services,
Repository—handles persisting data,
Service—contains core business logic of the APIs, and
Util—utility classes useful to other sub-components.

The key management service 114 may implement digital key tracking services and lifecycle management services for the tenant (e.g., vehicle OEM). The key management service 114 may be responsible for digital key termination, digital key suspend/resume, and vehicle unpairing. The key management service 114 may operate in cooperation with the key tracking service 116 to facilitate digital key tracking services and lifecycle management services. The key management service 114 may include the following sub-components:
Config—handles configuration of the web service,
Controller—defines the web APIs and accepts incoming requests to the APIs,
DAO—data persistence classes,
DTO—data transfer classes,
Gateway—handles outgoing requests to the Internet or other web services,
Repository—handles persisting data,
Security—implements securing of access to the APIs,
Service—contains core business logic of the APIs, and
Util—utility classes useful to other sub-components.

The key tracking service 116 implements the tracking of digital keys and provides receipts. In some examples, the key tracking service 116 maintains a digital key database that is configured to associate digital key records with each of the digital keys issued in conjunction with the digital key cloud services platform 100, i.e., to maintain digital key records for digital owner keys and digital friend keys.

The digital key tracking provided by the key tracking service 116 may provide a ledger of digital key transactions allowing the digital key cloud services platform 100 to maintain a history of all changes to a digital key. In one example, the key management service 114 may create a record of a digital key transaction originating from a vehicle or phone and then send a request to the key tracking service 116 to create a ledger or entry of the digital key transaction. Upon creating the ledger for the digital key transaction, the key tracking service 116 may further create a receipt of the digital key transaction. The receipt may be returned to the vehicle 104 or device 102, e.g., a mobile or smart phone, by the key tracking service 116 or the key management service 114 as proof that the vehicle 104 or the device 102 successfully completed the key tracking process. The key tracking service 116 may include the following sub-components:
Config—handles configuration of the web service,
Controller—defines the web APIs and accepts incoming requests to the APIs,
DAO—data persistence classes,
DTO—data transfer classes,
Gateway—handles outgoing requests to the Internet or other web services,
Repository—handles persisting data,
Service—contains core business logic of the APIs, and
Util—utility classes useful to other sub-components.

A tenant context web service allows the administration service 110 to retrieve the system configurations set up by the tenant. The tenant context web service may include the following sub-components:
Config—handles configuration of the web service,
Controller—defines the web APIs and accepts incoming requests to the APIs,
DAO—data persistence classes,
DTO—data transfer classes,
Gateway—handles outgoing requests to the Internet or other web services,
Repository—handles persisting data,
Security—implements securing of access to the APIs, and
Service—contains core business logic of the APIs.

The vehicle integration service 122 routes and translates messages to and from the administration service 110 and the vehicle OEM (i.e., tenant). In other words, the digital key cloud services platform 100 may communicate with the vehicle OEM through the vehicle integration service 122. The vehicle integration service 122 may include the following sub-components:
Config—handles configuration of the web service,
Controller—defines the web APIs and accepts incoming requests to the APIs,
DAO—data persistence classes,
DTO—data transfer classes,
Gateway—handles outgoing requests to the Internet or other web services,
Repository—handles persisting data,
Service—contains core business logic of the APIs, and
Util—utility classes useful to other sub-components.

The administrative support service 120 allows tenants to configure and customize their digital key service via an administrative web service API. The administrative support service 120 may include the following sub-components:
Config—handles configuration of the web service,
Controller—defines the web APIs and accepts incoming requests to the APIs,
DAO—data persistence classes,
DTO—data transfer classes,
Gateway—handles outgoing requests to the Internet or other web services,
Repository—handles persisting data,
Security—implements securing of access to the APIs, and
Service—contains core business logic of the APIs.

The administrative support service 120 allows a tenant to call the administration web service API via a graphical user interface.

The digital key cloud services platform 100 may further include a SBOD service proxy service in communication with the SBOD service 112 and a CCC API broker service 118 in communication with the key management service 114.

The SBOD service proxy service may route incoming calls from a fleet management company service 126 to the SBOD service 112.

The CCC API broker service 118 may establish a TLS or MTLS connection with the device OEM services platform 106 and route incoming calls to the key management service 114.

The vehicle OEM services platform 108 may include a vehicle CA service 130, a digital key (DK) service integration service 132 (i.e., DK integration), a vehicle OEM core service 134, and a telematics link service 136. The digital key cloud services platform 100 may be in communication with the vehicle OEM services platform 108 via one or more APIs.

The vehicle OEM services platform 108 may act as the certificate authority for this CCC product. The digital key cloud services platform 100 may use APIs and methods provided by the vehicle OEM services platform 108 to obtain any necessary certificates and public keys required to perform digital key service functions.

The vehicle OEM services platform 108 may securely share, generate, provide, provision, etc. a variety of the certificates set forth in the CCC specification.

In some examples, the vehicle OEM services platform 108 is configured to support a version of certificate [J] (i.e., vehicle OEM CA certificate) and any relevant vehicle OEM CA certificates, such as certificate [F] (i.e., device OEM CA certificate), with the digital key cloud services platform 100. The digital key cloud services platform 100 may use certificates [J] and [F] to verify other certificates in the certificate chain (e.g., certificate [E]), and may use certificate [J]'s private key to sign certificate [K].

The device 102 includes a variety of services, APIs, applications, etc. to facilitate supporting digital key sharing via the digital key cloud services platform 100 and the vehicle 104. In some examples, the device 102 includes a fleet application 144 to facilitate communications with the fleet management company service 126, a native application 146 (e.g., an operating system), a vehicle application 148 to facilitate communications with the vehicle OEM core service 134, and a DK framework service 150 configured to facilitate digital key sharing via a digital key sharing relay 152, the vehicle 104, and/or other devices and/or vehicles.

Likewise, the vehicle 104 includes a variety of services, APIs, applications, etc. to facilitate supporting digital key sharing via the digital key cloud services platform 100 and the device 102. In some examples, the vehicle 104 includes one or more anchors 160 (e.g., UWB, BLE, NFC) to facilitate wireless communications with the device 102, a DK electronic control unit (DK ECU) 162 to support digital keys and related processes, and a telematics control unit (TCU) 164 to facilitate communications with the telematics link service 136.

At several points during the lifetime of a digital key, communication between the vehicle 104 and the digital key cloud services platform 100 is necessary. This includes during key tracking, key suspension and resumption, key termination, and vehicle unpairing. Communication between the digital key cloud services platform 100 and the vehicle 104 may be routed through the vehicle OEM services platform 108.

The digital key cloud services platform 100 will support at least the incoming and outgoing message types described in Table 1 and Table 2.

TABLE 1
Vehicle to digital key service message types

| Message Type | Purpose |
|---|---|
| VEHICLE_KEY_SIGNING_ | Send a signing request for the creation |
| REQUEST | of certificate [K] |
| TERMINATE_KEY_REQUEST | Initiate key termination from the vehicle |
| VEHICLE_KEY_SUSPENDED | Inform DKS that a key has been |
| | suspended in the vehicle |
| VEHICLE_KEY_RESUMED | Inform DKS that a key has been |
| | resumed in the vehicle |
| VEHICLE_KEY_TERMINATED | Inform DKS that a key has been |
| | terminated in the vehicle |
| VEHICLE_UNPAIRED | Inform DKS that a vehicle has been |
| | unpaired from a key |
| OWNER_PAIRING_ | Inform DKS that an owner pairing |
| VERIFIER_EXPIRED | verifier has expired |
| ACKNOWLEDGE_MESSAGE | Acknowledge a message sent to a vehicle |

TABLE 2
digital key service to vehicle message types

| Message Type | Purpose |
|---|---|
| VEHICLE_KEY_SIGNING_ | Send a signed certificate [K] to a vehicle |
| RESPONSE | |
| SUSPENSION_REQUEST | Initiate key suspension in a vehicle |
| RESUME_REQUEST | Initiate key resumption in a vehicle |
| TERMINATION_REQUEST | Initiate key termination in a vehicle |
| UNPAIR_REQUEST | Initiate unpairing of a key from a vehicle |
| OWNER_PAIRING_ | Send a new owner pairing verifier |
| VERIFIER | to a vehicle |
| ACKNOWLEDGEMENT | Acknowledge a message sent to DKS |

The digital key cloud services platform 100 will use and understand at least the JSON message structure when communicating with vehicles. The digital key cloud services platform 100 will use at least HTTPS as the transport method for vehicle messages.

The digital key cloud services platform 100 may support the provisioning of a new vehicle during its production phase. Provisioning a vehicle informs the digital key cloud services platform 100 that the vehicle exists and provides the vehicle public key certificate [K] (i.e., vehicle public key certificate) so that the digital key cloud services platform 100 can identify the origin of the vehicle's public key.

The vehicle OEM may request certificate [K] creation and owner pairing verifier creation from the digital key cloud services platform 100 during vehicle provisioning.

The digital key cloud services platform 100 may understand and implement the following API commands and message structure when receiving vehicle management communication from the vehicle OEM:

```
  CreateCertificateKRequest(csrHexString *string*)
  CreateCertificateKResponse(vehicleId *string*, certificateHexString
*string*)
  GenerateOwnerPairingVerifier(password *string*, sendMessage
*Boolean*)
  OwnerPairingVerifier(salt *string*, lx *string*, ly *string*, w0 *string*, nScrypt
*integer*, r *integer*, p *integer*, dkLen *integer*)
  CertificateK(certificate *string*)
  VehicleInfoResponse(id *string*, vehicleId *string*, tenantId *string*,
uiIdentifier *string*, certificateK *string*, brand *string*, model *string*,
maxSharedKeys *integer*, updated *string*)
  LimitedVehicleInfo(uiIdentifier *string*, brand *string*, model *string*,
maxSharedKeys *integer*, immobilizerAndSlotIdTag *string*,
suspendResumeSupported *boolean*)
  UpdateLimitedVehicleInfo(uiIdentifier *string*, brand *string*, model
*string*, maxSharedKeys *integer*, suspendResumeSupported *boolean*)
```

The digital key cloud services platform 100 may support vehicle-initiated provisioning and factory-initiated provisioning.

In vehicle-initiated provisioning, a key pair is generated on the vehicle and a vehicle public key certificate certificate signing request (CSR) is sent to the digital key cloud services platform 100. The digital key cloud services platform 100 may sign the CSR, create a vehicle public key certificate [K], and return the vehicle public key certificate [K] back to the vehicle 104.

Initiating vehicle public key certificate [K] signing from the vehicle 104 adds additional security since the secure key never leaves the vehicle. Re-provisioning is possible since the vehicle knows how to regenerate the key pair. Further, vehicle-initiated provisioning may be performed on new vehicles in lieu of factory-initiated provisioning.

In factory-initiated provisioning, a key pair and vehicle public key certificate [K] are generated outside of the vehicle 104 and are later flashed to the vehicle 104 by the factory or dealer. Once on the vehicle 104, a factory/dealer can initiate vehicle public key certificate [K] signing with the already-generated certificate.

In some examples, the private key is generated on the vehicle and effectively never leaves the vehicle under most circumstances. In a factory provisioning, a triggering event for generating the private key, for example, includes a diagnostic message from the factory or dealership. In a field provision, in contrast, the triggering event for generating a private key, for example, includes an in-vehicle command, e.g., HMI command, from the dealership or an end-user.

The digital key cloud services platform 100 may initiate key termination and unpairing when, for example, a tenant or user terminates a key via the vehicle OEM website.

The digital key cloud services platform 100 may implement the following APIs when sending or receiving key management communication to or from the vehicle OEM:
KeyTerminationRequest(keyId *string*, keyType *string*)
requestUnpairing(tenantId *string*, vehicleId *string*)
requestTermination(tenantId *string*, vehicleId *string*)

The digital key cloud services platform 100, upon an owner's initial pairing of their device with a vehicle, may track a new digital key. The owner's mobile device may be notified once their digital key has been tracked.

Following successful pairing by the owner, the digital key cloud services platform 100 may allow the sharing of digital keys. Specifically, the key tracking service 116 may create and track new digital keys for each time a key is shared.

The digital key cloud services platform 100 may further allow owner key unpairing, which will terminate all keys associated with the vehicle in the key tracking service 116. Neither the owner nor any shared keys may access the vehicle.

The digital key cloud services platform 100 may allow reprovisioning of a vehicle once an owner key is unpaired or if it is otherwise manually triggered. During the reprovisioning, as in owner key unpairing, all keys associated with the vehicle are terminated. Neither the owner nor any shared keys may access the vehicle. The digital key cloud services platform 100 may then proceed to provision the vehicle in a manner discussed above.

During the owner key unpairing or provisioning process, the digital key cloud services platform 100 may remove all shared keys associated with the vehicle. Shared keys (or friend keys) are digital keys that may be associated with mobile devices belonging to someone other than the owner. In one example, the shared key may be managed by the device OEM of the friend's mobile device. In this example, the digital key cloud services platform 100 may delete a shared key from the friend's mobile device by sending a request to the device OEM services platform 106.

In another example, the shared key may be managed by the vehicle OEM services platform 108. In this example, the digital key cloud services platform 100 may delete a shared key from the friend's mobile device by sending a request to the vehicle OEM services platform 108.

The digital key cloud services platform 100 may further allow the suspension and resumption of shared digital keys by the owner or vehicle OEM. This may be done in lieu of deletion of the shared key. Once suspended, a shared digital key may not access the vehicle until the shared key is resumed by the owner or vehicle OEM.

The digital key cloud services platform 100 may send notification messages to the vehicle OEM services platform 108 at various points during the lifecycle of a digital key. The digital key cloud services platform 100 may communicate with the vehicle OEM services platform 108 through the vehicle integration service. This may include when a key is created, suspended, resumed, or terminated.

The digital key cloud services platform 100 may implement the following APIs when sending notification messages to or from the vehicle OEM services platform 108:

```
  CreateNotificationRequest(scmId *string*, vehicleId *string*, keyId *string*,
eventType *string*, eventData *string*)
  Notification(eventData *string*, eventType *string*, id(notificationId *string*,
timestamp *string*), keyId *string*, notificationId *string*, scmId *string*, timestamp
*string*, vehicleId *string*)
```

The digital key cloud services platform 100 may retrieve vehicle information from the vehicle OEM services platform 108 at various points during the lifecycle of a digital key. The digital key cloud services platform 100 may implement the following APIs when sending vehicle information requests to the vehicle OEM services platform 108:

```
  GetVehicleScmIdResponse(scmId *string*)
  GetFullVehicleInfo(brand *string*, certificate *string*, maxSharedKeys
*integer*, model *string*, uiIdentifier *string*)
```

The digital key cloud services platform 100 is predominantly described with respect to enabling digital key sharing in accordance with the CCC specification for non-limiting purposes as the present disclosure is similarly applicable and beneficial in enabling digital key sharing according to other specifications. In order to support digital key sharing according to the CCC specification, however, the vehicle 104 is to be provisioned with a vehicle public key certificate 172, or more specifically, the certificate [K] described therein. In some examples, the vehicle public key certificate 172 is used to support authentications performed between the device 102 and the vehicle 104 as part of the CCC specification.

Notably, the CCC specification fails to specify a particular methodology or process for provisioning the vehicle 104 with the vehicle public key certificate 172. To fill this gap, the digital key cloud services platform 100 is configured for provisioning the vehicle 104 with the vehicle public key certificate 172. In some examples, the digital key cloud services platform 100 is an independent, third-party platform provided to assist vehicle OEMs in provisioning the vehicle 104, and optionally, to alleviate a need for the vehicle OEMs to maintain compliance with the CCC specification.

To this end, the APIs, services, modules, and other features of the digital key cloud services platform 100 include capabilities for working with existing infrastructures of vehicle OEMs via the vehicle OEM services platform 108 maintained by the vehicle OEMs. In some examples, the digital key cloud services platform 100 provisions the vehicle 104 with the vehicle public key certificate 172 in a manner that is effectively transparent to the vehicle OEMs, or at the least in a manner that minimizes the need for the vehicle OEMs to continuously support the CCC specification and updates thereto.

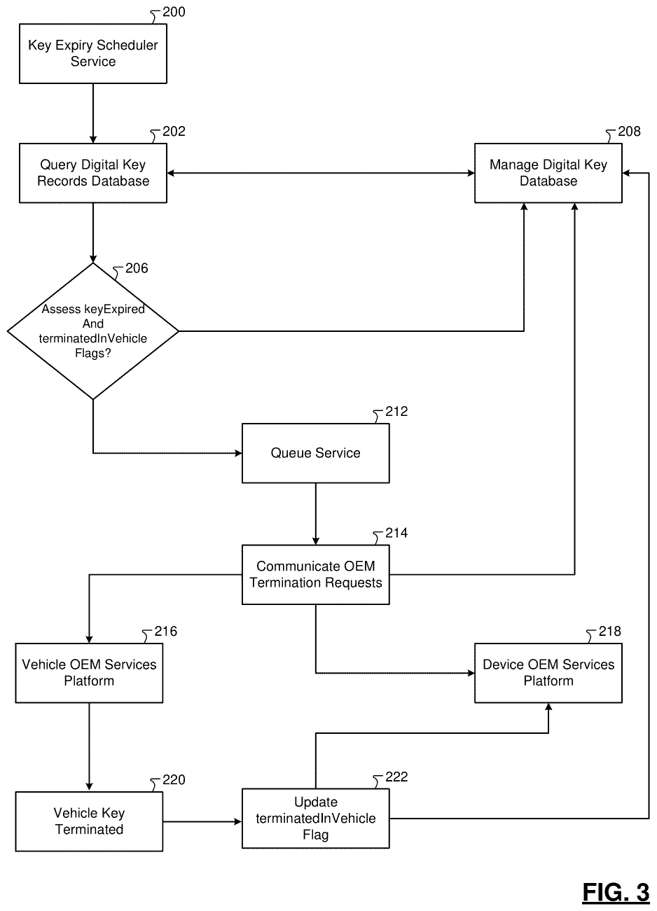

Referring to FIG. 3, a method for managing digital friend keys for a plurality of vehicles is shown. As noted in the CCC specification, digital friend keys are differentiated from digital owner keys. The digital owner keys, for example, correspond with digital keys provided to an owner device of an owner of a vehicle, i.e., digital keys that are provided to an owner device or a key fob at the time of vehicle purchase to permit access to the tied-to vehicle. In contrast, the digital friend keys, for example, correspond with digital keys provided to a friend device of a friend or other entity by the owner of the vehicle or other conveyor, e.g., vehicle OEM, device OEM, etc., that permit the friend device access to the tied-to vehicle.

Typically, the digital owner keys have greater or different entitlements than the digital friend keys, optionally with entitlements of the digital friend keys specified by the owner of the tied-to vehicle and the entitlements of the digital owner keys specified by the vehicle OEM of the tied-to vehicle. In this manner, digital key cloud services platform 100 is configured to support the use of differing digital keys concurrently across multiple devices, devices from multiple device OEMs, multiple vehicles, and vehicles from multiple vehicle OEMs. While the digital cloud services platform 100 is operable to support managing other types of digital keys, key pairs, etc., for presentation simplicity, the digital keys managed herein are predominantly presented with respect to digital friend keys and digital owner keys.

Notably, the CCC specification fails to specify a required methodology or process for managing certain aspects of the digital keys, particularly with respect to managing the digital friend keys. In some circumstances, the digital friend keys may be created in accordance with the CCC specification with entitlements that are limited in time or to certain events, i.e., the digital friend keys are treated with the intention that the digital friend keys will be terminated upon expiration of the entitlements. The CCC specification, however, fails to adequately describe how a vast quantity of digital friend keys are to be managed after issuance, let alone how to track an expiration date of the digital friend keys and to correspondingly terminate the digital friend keys that have exceeded their expiration date.

To this end, the APIs, services, modules, and other features of the digital key cloud services platform 100 include capabilities for managing the digital friend keys on behalf of the device OEMs services platform 106 and the vehicle OEM services platform 108, particularly with respect to tracking expiration dates of the digital friend keys and terminating the digital friend keys that have exceeded their expiration date. Optionally, the managing of the digital friend keys with the digital key cloud services platform 100 is provided in a manner that is effectively transparent to the vehicle and device OEMs, or at least in a manner that minimizes the need for the vehicle and/or device OEMs to continuously support the CCC specification and updates thereto.

At 200, the method includes the key management service 104 instantiating a key expiry scheduler service for managing termination of expired digital friend keys. In some examples, the key expiry scheduler service is operable to identify expired digital friend keys based on the digital key records kept in the digital key database, with the expired keys corresponding with those having an expiration date that exceeds a selected expiration date. The key expiry scheduler, for example, selects a past, current, or future date as the selected expiration date such that the key records having dates in excess of the selected expiration date are considered as expired keys.

In some examples, the digital key records for the digital friend keys are created by the key tracking service 116 in response to entitlements specified by the owner of the vehicle intended to be tied to the corresponding digital friend key. The entitlements, for example, are specified within a key creation request transmitted to the vehicle integration service 122 from the DK integration service 132 of the vehicle OEM services platform 108 of the vehicle intended to be tied to the digital friend key. The entitlements in the key creation request are, in some instances, created as a function of the vehicle OEM core services 134 or the device OEMs services platform 106 communicating with an owner device of the owner or directly with the vehicle 104 to be tied to the corresponding digital friend key to determine the entitlements.

In some examples, the digital friend keys result from the owner device providing a sharing invitation to a friend device intended to be tied to the digital friend key. The owner device and the friend device thereafter perform a handshake or other authentication in accordance with the CCC specification to facilitate establishing the digital friend key. This process may optionally define the expiration date of the digital friend key and/or other triggers for its termination, e.g., number of uses, location of use, etc. For the sake of presentation simplicity and without limitation, the termination of the friend keys is described with respect to the corresponding expiration date exceeding a selected expiration date; however, similar processes may be performed for other termination triggering activities.

At 202, the method includes the key expiry scheduler service issuing a query to the digital key database for the digital key records. In some examples, the digital friend key database is tasked with maintaining digital key records for unexpired digital friend keys and expired digital friend keys. In addition to keeping records for unexpired digital friend keys, in some circumstances, the digital friend key database is also tasked with archiving, optionally for a specified period of time, records for expired digital friend keys. Accordingly, the query may be limited to requesting that the digital friend key database provide only the digital key records for the unexpired digital friend keys.

In some examples, the digital key records each include a keyExpired flag set by the key tracking service 116 in response to messaging received from the key management service 114 at the time of creating the digital key records. The keyExpired flag is used to track an expiration status of the associated digital friend key within the digital key database. The key tracking service 116, for example, sets the keyExpired flag to an unexpired state to indicate that the digital friend key associated therewith is unexpired and to an expired state to indicate that the digital friend key associated therewith has expired.

In some examples, the digital key records also include a terminatedInVehicle flag set by the key tracking service 116 in response to messaging received from the key management service 114 at the time of creating the digital key records. The terminatedInVehicle flag is used to track whether the corresponding digital friend key has been deleted from the vehicle tied thereto. The key tracking service 116, for example, sets the terminatedInVehicle flag to an active state to indicate that the digital key associated therewith has not been terminated in the vehicle tied thereto and to an inactive state to indicate that the digital friend key associated therewith has been terminated in the vehicle tied thereto.

Accordingly, the query at 202 may be used to instruct the digital key database to provide all or some of the digital key records. The query, for example, may be used to request the digital friend key database to provide the digital friend key records having an expiration date exceeding a selected past, current, or future expiration date, the digital friend key records having the keyExpired flag set to the unexpired state, and/or the digital friend key records having the terminatedInVehicle flag set to the active state.

At 206, the method includes the key expiry scheduler service performing an expiration assessment of the digital key records recovered at 202 to identify the expired digital friend keys. The expiration assessment, for example, corresponds with the key expiry scheduler service assessing each of the digital key records individually to determine whether the expiration date has expired, i.e., whether the expiration date has exceeded the selected expiration date, whether the keyExpired flag is set to the unexpired state or the expired state, and whether the terminatedInVehicle flag is set to the active state or the inactive state.

In some examples, the query at 202 requests the digital key records associated with the friend keys that have an expiration date in excess of the selected expiration date, optionally without regard to the current states of the keyExpired flag and the terminatedInVehicle flag.

In some circumstances, the keyExpired flag may be changed from the unexpired state to the expired state and/or the terminatedInVehicle flag may be changed from the active state or the inactive state independently or without awareness of the key expiry scheduler service. Such a scenario can arise, for example, in the event the related vehicle OEM has already terminated the corresponding friend keys within the related vehicle and apprised the key tracking service 116 to relatedly change the terminatedInVehicle flag state. If this occurs, limiting the query to the digital key records having the keyExpired flag set to the unexpired state and/or the terminatedInVehicle flag set to the active state may result in omitting digital key records that have not been completely terminated from future use.

The expiration assessment at 206 includes the key expiry scheduler services managing the digital key database at 208 to account for any of the queried digital key records already having either the keyExpired flag set to the expired state or the terminatedInVehicle flag set to the inactive state. In other words, some of the digital key records may have the keyExpired flag set to the expired state and/or the terminatedInVehicle flag set to the inactive state even though the associated digital friend key has not exceeded the expiration date specified in its entitlements. As mentioned above, this may occur in the event either of the keyExpired flag and the terminatedInVehicle flag are adjusted in the digital key database independently.

In the case of some of the digital key records already having one of the keyExpired flag set to the expired state or the terminatedInVehicle flag set to the inactive state, the method at 208 updates the digital key database to omit the corresponding digital key records from further querying at 202. In some examples, this includes the key expiry schedule service instructing the key tracking service 116 to archive the corresponding digital key records to avoid future queries at 202 obtaining the same digital key records in subsequent management operations.

Additionally, for the digital key records retrieved at 202 that have exceeded their expiration date but do not already have the keyExpired flag set to the expired state or the terminatedInVehicle flag set to the inactive state, the processes at 208 selects these digital key records for further management. In particular, the method includes managing the related digital friend keys, or more specifically, updating the digital friend key database to remove the related digital friend keys from further processing and performing tasks in accordance with the CCC specification to apprise the friend device, device OEM of the friend device, the vehicle, and the vehicle OEM that the associated digital friend key has been terminated.

To this end, the method at 206 includes the key expiry scheduler service instructing the key tracking service 116 to update the keyExpired flag of the associated digital key record from the unexpired state to the expired state for the expired digital friend keys, i.e., those having the expiration date in excess of the selected expiration date. At this stage, the key expiry schedule service has identified the expired digital friend keys and updated the digital key database at 208 to ensure the keyExpired flags associated therewith have been changed to the expired state. Also at this stage, the terminatedInVehicle flag of the expired digital friend keys has not yet been updated to the inactive state, which as described below, is delayed until termination confirmation has been received from the associated vehicle.

At 212, the method includes the key expiry scheduler publishing the expired friend keys identified at 206 to a queue service. The queue service, for example, is used to schedule communication of additional messaging to apprise the vehicle OEM and/or the device OEM of the friend devices that the associated digital friend keys have expired and are to be terminated from further use. Optionally, the queue service schedules communication of the related messaging and other activities to avoid overloading messaging systems of the vehicle and/or device OEMs, or more particularly the device OEM services platform 106 and the vehicle OEM services platform 108 associated therewith.

At 214, the method includes the key management service 114 communicating a vehicle OEM termination request message at 216 to the vehicle OEM services platform 108 of each of the vehicles associated with one of the expired digital friend keys. The vehicle OEM termination request message, for example, is used to request the vehicle OEM services platform 108 in receipt thereof to delete the related digital friend key from the vehicle 104 tied thereto.

At 214, the method also includes a key management service 114 communicating a device OEM termination request message at 218 to the device OEM services platform 106 of each of the friend devices associated with one of the expired digital friend keys. The device OEM termination request message, for example, is used to request the device OEM services platform 106 in receipt thereof to delete the related digital friend key from the friend device 102 tied thereto.

At 220, the method includes the vehicle OEM services platform 108 receiving a key terminated message from the vehicles in receipt of the vehicle OEM termination request messages. The key terminated messages, for example, are used by the vehicle 104 associated therewith to confirm deletion of the expired digital friend key identified in the related vehicle OEM termination request message.

At 222, the method includes the key tracking service 116 updating the terminatedInVehicle flag from the active state to the inactive state for the expired digital friend keys. At this stage, the keyExpired flag and the terminatedInVehicle flag in the digital key database have been updated in the digital key database at 208, thereby completing termination of the expired digital friend keys.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in a different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A digital key cloud services platform for managing digital friend keys for a plurality of vehicles, comprising:
a key tracking service configured to track digital friend keys issued to a plurality of friend devices, wherein the digital friend keys are each respectively tied to one of the plurality of friend devices to entitle a friend device of the plurality of friend devices tied thereto access to one of the plurality of vehicles; and
a key management service configured to provide a key expiry scheduler service for managing termination of expired digital friend keys, wherein the expired digital friend keys correspond with respective ones of the digital friend keys identified for termination.

2. The digital key cloud services platform according to claim 1, wherein the key tracking service manages a digital key database configured to associate a digital key record with each of the digital friend keys.

3. The digital key cloud services platform according to claim 2, wherein each of the digital key records includes an expiration date representing a date on which the digital friend key associated therewith is intended for termination.

4. The digital key cloud services platform according to claim 3, wherein the key expiry scheduler service is configured to query the digital key database to identify the expired digital friend keys.

5. The digital key cloud services platform according to claim 4, wherein the key expiry scheduler service is configured to identify the expired digital friend keys to include the digital friend keys associated with the digital key records that have the expiration date in excess of a selected expiration date.

6. The digital key cloud services platform according to claim 5, wherein the key tracking service is configured to set the expiration date for each of the digital key records according to entitlements specified by a digital key integration service of a vehicle original equipment manufacturer (OEM) services platform of a vehicle OEM of the vehicle associated therewith.

7. The digital key cloud services platform according to claim 4, wherein each of the digital key records includes a keyExpired flag, wherein the key tracking service sets the keyExpired flag to an unexpired state to indicate that the digital friend key associated therewith is unexpired and to an expired state to indicate that the digital friend key associated therewith has expired.

8. The digital key cloud services platform according to claim 7, wherein each of the digital key records includes a terminatedInVehicle flag, wherein the key tracking service sets the terminatedInVehicle flag to an active state to indicate that the digital key associated therewith has not been terminated in the vehicle tied thereto and to an inactive state to indicate that the digital friend key associated therewith has been terminated in the vehicle tied thereto.

9. The digital key cloud services platform according to claim 8, wherein the key expiry scheduler service is configured to instruct the key tracking service to update the keyExpired flag from the unexpired state to the expired state for the digital key records associated with the expired digital friend keys.

10. The digital key cloud services platform according to claim 9, wherein the key expiry scheduler service is configured to instruct the key management service to communicate a vehicle OEM termination request message to the vehicle OEM services platform of each of the vehicles associated with the expired digital friend keys.

11. The digital key cloud services platform according to claim 10, wherein each vehicle OEM termination request message is operable to request the vehicle OEM services platform in receipt thereof to delete the digital friend key associated therewith from the vehicle tied thereto.

12. The digital key cloud services platform according to claim 11, wherein the key management service is configured to receive vehicle OEM key terminated messages from the vehicle OEM services platforms to confirm deletion of the expired digital friend keys associated with the vehicle OEM termination request messages.

13. The digital key cloud services platform according to claim 12, wherein the key expiry scheduler service is configured to instruct the key tracking service to update the terminatedInVehicle flag from the active state to the inactive state for the digital key records associated with the expired digital friend keys.

14. The digital key cloud services platform according to claim 12, wherein the key expiry scheduler service is configured to instruct the key management service to communicate device OEM termination request messages to device OEM services platform of each of the friend devices associated with the expired digital friend keys.

15. The digital key cloud services platform according to claim 10, wherein the key expiry scheduler service is configured to instruct the key management service to communicate a device OEM termination notification message to a device OEM services platform of each of the friend devices associated with the expired digital friend keys.

16. The digital key cloud services platform according to claim 1, wherein the digital friend keys operate independently of digital owner keys, wherein the digital owner keys are each respectively tied to one or more owner devices to entitle the owner device tied thereto access to one of the plurality of vehicles.

17. The digital key cloud services platform according to claim 1, wherein the digital friend keys are friend keys defined according to the Car Connectivity Consortium® (CCC) Version 1.1.0 specification.

18. A method for managing digital friend keys for a plurality of vehicles, comprising:
tracking digital friend keys issued to a plurality of friend devices with a key tracking service, wherein the digital friend keys are each respectively tied to one of the plurality of friend devices to entitle a friend device of the plurality of friend devices tied thereto access to one of the plurality of vehicles;
managing a digital key database to associate a digital key record with each of the digital friend keys, wherein each of the digital key records includes an expiration date representing a date on which the digital friend key associated therewith is intended for termination; and
managing termination of expired digital friend keys with a key expiry scheduler service of a key management service, wherein the expired digital friend keys correspond with respective ones of the digital friend keys that have the expiration date in excess of a selected expiration date.

19. The method according to claim 18, further comprising communicating a vehicle original equipment manufacturer (OEM) termination request message from the key management service to a vehicle OEM services platform of each of the vehicles having one of the expired digital friend keys.

20. The method according to claim 19, wherein the digital friend keys are friend keys defined according to the Car Connectivity Consortium® (CCC) Version 1.1.0 specification.
